(19) United States
(12) Patent Application Publication
(10) Pub. No.: US 2015/0134258 A1
(43) Pub. Date: May 14, 2015

(54) Well Pressure Control Event Detection and Prediction Method

(71) Applicant: Schlumberger Technology Corporation, Sugar land, TX (US)

(72) Inventors: John Christian Luppens, Houston, TX (US); Oney Erge, Houston, TX (US); Chunling Gu Coffman, Houston, TX (US); Rustam Isangulov, Katy, TX (US)

(21) Appl. No.: 14/538,645

(22) Filed: Nov. 11, 2014

Related U.S. Application Data
(60) Provisional application No. 61/903,422, filed on Nov. 13, 2013.

(51) Int. Cl. E21B 47/06; E21B 44/00; G08B 21/18; E21B 49/00

(52) U.S. Cl. CPC E21B 47/06; E21B 49/005; E21B 44/00; G08B 21/182
USPC 702/11

(57) ABSTRACT

A method for identifying and predicting well pressure control events includes pumping fluid into a wellbore and collecting fluid returning from the wellbore. A first parameter related to a rate of flow of fluid pumped into the wellbore is measured. A second parameter related to a rate of flow of fluid out of the wellbore is measured. The first and second parameters and selected properties of the fluid are used to calculate an equivalent density of the fluid during pumping (ECD) and when pumping is stopped (ESD). An alarm when at least one of the following occurs: ECD is at least equal to a fracture pressure of at least one formation in the wellbore, ESD is at most equal to a fluid pore pressure of at least one formation in the wellbore, and ESD is at most equal to a collapse pressure of the wellbore.

### BACKGROUND

This disclosure relates generally to the field of wellbore construction. More specifically, the disclosure relates to methods for detecting and/or predicting well pressure control events.

Drilling wellbores through subsurface formations includes suspending a “string” of drill pipe (“drill string”) from a drilling unit or similar lifting apparatus and operating a set of drilling tools and rotating a drill bit generally disposed at the bottom end of the drill string. The drill bit may be rotated by rotating the entire drill string from the surface and/or by operating a motor disposed in the set of drilling tool. The motor may be, for example, operated by the flow of drilling fluid (“mud”) through an interior passage in the drill string. The mud leaves the drill string through the bit and returns to the surface through an annular space between the drilled wellbore wall and the exterior of the drill string. The returning mud cools and lubricates the drill bit, lifts drill cuttings to the surface and provides hydrostatic pressure to mechanically stabilize the wellbore and prevent fluid under pressure disposed in certain permeable formations exposed to the wellbore from entering the wellbore. The mud may also include materials to create an impermeable barrier (“filter cake”) on exposed formations having a lower fluid pressure than the hydrostatic pressure of the mud in the annular space so that mud will not flow into such formations in any substantial amount.

An important element in such wellbore drilling is monitoring the volume of fluid (or its corresponding flow rate) that actually returns from the wellbore compared with the amount and/or rate at which mud is pumped into the wellbore. In a related manner, monitoring the volume of fluid in the wellbore during “tripping” operations to account for the volume of drill string inserted into the well or withdrawn from the wellbore is also important. The importance of the foregoing two comparisons is that imbalances in volume and/or flow rates into and out of the wellbore have been known to correspond to what will be termed “pressure control events.” Such events may include, for example, influx of fluid into the wellbore from one or more exposed formations; loss of fluid into one or more formations; and/or mechanical collapse of the wellbore.

Methods known in the art for evaluating well pressure control events during wellbore operations are described for example, in U.S. Pat. No. 6,820,702 issued to Niedermayr et al.

### SUMMARY

A method according to one aspect for identifying and predicting well pressure control events includes pumping fluid into a wellbore and collecting fluid returning from the wellbore. A first parameter related to a rate of flow of fluid pumped into the wellbore is measured. A second parameter related to a rate of flow of fluid out of the wellbore is measured. The first and second parameters and selected properties of the fluid are used to calculate an equivalent density of the fluid during pumping (ECD) and when pumping is stopped (ESD). An alarm when at least one of the following occurs: ECD is at least equal to a fracture pressure of at least one formation in the wellbore, ESD is at most equal to a fluid pore pressure of at least one formation in the wellbore, and ESD is at most equal to a collapse pressure of the wellbore.

A system for identifying and predicting well pressure control events according to another aspect of the disclosure includes a first sensor for measuring at least a first parameter related to a rate of flow of fluid pumped into a wellbore, the sensor in signal communication with a computer and a second sensor for measuring at least a second parameter related to a rate of flow of fluid out of the wellbore, the second sensor in signal communication with the computer. The computer comprises instructions programmed therein for using the first and second parameters and selected properties of the fluid to calculate an equivalent density of the fluid during pumping (ECD) and when pumping is stopped (ESD). The computer comprises instructions programmed therein to generate an alarm indicator and to operate a display in signal communication with the computer to display the alarm indicator when at least one of the following occurs:

ECD is at least equal to a fracture pressure of at least one formation in the wellbore; ESD is at most equal to a fluid pore pressure of at least one formation in the wellbore; and ESD is at most equal to a collapse pressure of the wellbore.

Other aspects and advantages will be apparent from the description and claims that follow.

### BRIEF DESCRIPTION OF THE DRAWINGS

FIG. 1 shows an example drilling and measurement system.

FIG. 2 is a flow chart of an example well pressure control event detection and prediction method according to the present disclosure.

FIG. 3 is a flow chart of an example method for estimating equivalent circulating density (ECD) of drilling fluid when wellbore annular pressure measurements are not available.

FIG. 4 shows a flow chart of an example method for calculating equivalent static density of drilling fluid.

FIG. 5 shows an example of automatic calibration of a flowmeter.

FIG. 6 shows an example display for use by drilling personnel.

FIG. 7 shows an example computer system that may be used in some embodiments.

### DETAILED DESCRIPTION

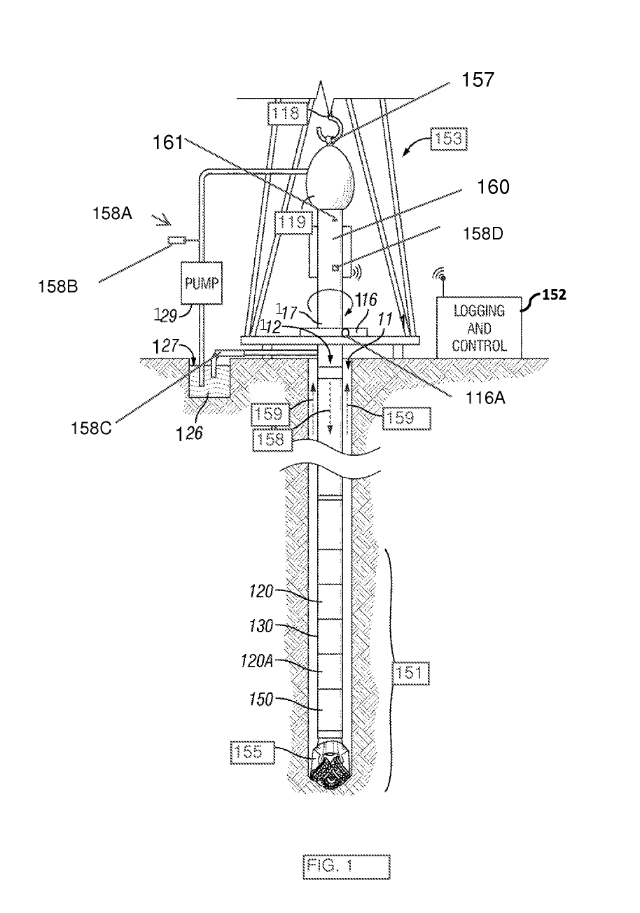

FIG. 1 shows a simplified view of an example drilling and measurement system that may be used in some embodiments. The drilling and measurement system shown in FIG. 1 may be deployed for drilling either onshore or offshore wellbores. In a drilling and measurement system as shown in FIG. 1, a wellbore 111 may be formed in subsurface formations by rotary drilling in a manner that is well known to those skilled in the art. Although the wellbore 111 in FIG. 1 is shown as being drilled substantially straight and vertically, some embodiments may be directionally drilled, i.e., along a selected trajectory in the subsurface.

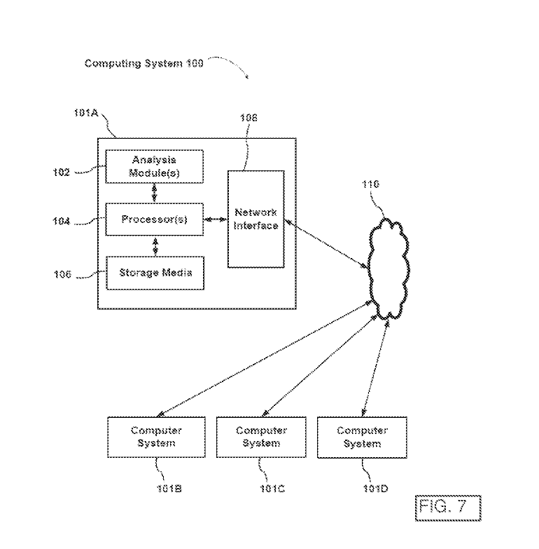

A drill string 112 is suspended within the wellbore 111 and has a bottom hole assembly (BHA) 151 which includes a drill bit 155 at its lower (distal) end. The surface portion of the drilling and measurement system includes a platform and derrick assembly 153 positioned over the wellbore 111. The platform and derrick assembly 153 may include a rotary table 116, kelly 117, hook 118 and rotary swivel 119 to suspend, axially move and rotate the drill string 112. In a drilling operation, the drill string 112 may be rotated by the rotary table 116 (energized by means not shown), which engages the kelly 117 at the upper end of the drill string 112. Rotational speed of the rotary table 116 and corresponding rotational speed of the drill string 112 may be measured by a rotational speed sensor 116A, which may be in signal communication with a computer or computer system (FIG. 7) in a surface logging, recording and control system 152 (explained further below). The drill string 112 may be suspended in the wellbore 111 from a hook 118, attached to a traveling block (also not shown), through the kelly 117 and a rotary swivel 119 which permits rotation of the drill string 112 relative to the hook 118 when the rotary table 116 is operates. As is well known, a top drive system (not shown) may be used in other embodiments instead of the rotary table 116, kelly 117 and swivel rotary 119.

Drilling fluid (“mud”) 126 may be stored in a tank or pit 127 disposed at the well site. A pump 129 moves the drilling fluid 126 to from the tank or pit 127 under pressure to the interior of the drill string 112 via a port in the swivel 119, which causes the drilling fluid 126 to flow downwardly through the drill string 112, as indicated by the directional arrow 158. The drilling fluid 126 travels through the interior of the drill string 112 and exits the drill string 112 via ports in the drill bit 155, and then circulates upwardly through an annular space between the outside of the drill string 112 and the wall of the borehole, as indicated by the directional arrows 159. In this known manner, the drilling fluid 126 lubricates and cools the drill bit 155 and carries formation cuttings created by the drill bit 155 up to the surface as the drilling fluid 126 is returned to the pit 127 for cleaning and recirculation. Pressure of the drilling fluid as it leaves the pump 129 may be measured by a pressure sensor 158A in pressure communication with the discharge side of the pump 129 (at any position along the connection between the pump 129 discharge and the upper end of the drill string 112). The pressure sensor 158A may be in signal communication with the computer or computer system forming part of the surface logging, recording and control system 152, to be explained further below. A drilling fluid flow volume or flow rate sensor 158B may also be in fluid communication with the discharge side of the pump 129. The fluid volume or flow sensor 158B may be implemented as a stroke counter (i.e., a summing register that displays a number of cycles of each cylinder in a single or multiple cylinder positive displacement pump), or a volumetric or mass flow rate sensor such as Coriolis-type flow meter.

The drill string 112 typically includes a BHA 151 proximate its distal end. In the present example embodiment, the BHA 151 is shown as having a measurement while drilling (MWD) module 130 and one or more logging while drilling (LWD) modules 120 (with reference number 120A depicting a second LWD module 120). As used herein, the term “module” as applied to MWD and LWD devices is understood to mean either a single instrument or a suite of multiple instruments contained in a single modular device. In some embodiments, the BHA 151 may include a “steerable” hydraulically operated drilling motor of types well known in the art, shown at 150, and the drill bit 155 at the distal end.

The LWD modules 120 may be housed in one or more drill collars and may include one or more types of well logging instruments. The LWD modules 120 may include capabilities for measuring, processing, and storing information, as well as for communicating with the surface equipment. By way of example, the LWD module 120 may include, without limitation one of a nuclear magnetic resonance (NMR) well logging tool, a nuclear well logging tool, a resistivity well logging tool, an acoustic well logging tool, or a dielectric well logging tool, and so forth, and may include capabilities for measuring, processing, and storing information, and for communicating with surface equipment, e.g., the surface logging, recording and control unit 152.

The MWD module 130 may also be housed in a drill collar, and may contain one or more devices for measuring characteristics of the drill string 112 and drill bit 155. In the present embodiment, the MWD module 130 may include one or more of the following types of measuring devices: a weight-on-bit (axial load) sensor, a torque sensor, a vibration sensor, a shock sensor, a stick/slip sensor, a direction measuring device, and an inclination and geomagnetic or geodetic direction sensor set (the latter sometimes being referred to collectively as a “D&I package”). The MWD module 130 may further include an apparatus (not shown) for generating electrical power for the downhole system. For example, electrical power generated by the MWD module 130 may be used to supply power to the MWD module 130 and the LWD module(s) 120. In some embodiments, the foregoing apparatus (not shown) may include a turbine-operated generator or alternator powered by the flow of the drilling fluid 126. It is understood, however, that other electrical power and/or battery systems may be used to supply power to the MWD and/or LWD modules.

In the present example embodiment, the drilling and measurement system may include a torque sensor 158D proximate the surface. The torque sensor 158D may be implemented, for example in a sub 160 disposed proximate the top of the drill string 112, and may communicate wirelessly to the computer or computer system in the surface logging, recording and control system 152, explained further below. In other embodiments, the torque sensor 158D may be implemented as a current sensor coupled to an electric motor (not shown) used to drive the rotary table 116. In the present example embodiment, an axial load (weight) on the hook 118 may be measured by a hookload sensor 157, which may be implemented, for example, as a strain gauge. The sub 160 may also include a hook elevation sensor 161 for determining the elevation of the hook 118 at any moment in time. The hook elevation sensor 161 may be implemented, for example as an acoustic or laser distance measuring sensor. Measurements of hook elevation with respect to time may be used to determine a rate of axial movement of the drill string 112. The hook elevation sensor may also be implemented as a rotary encoder coupled to a winch drum used to extend and retract a drill line used to raise and lower the hook (not shown in the Figure for clarity). Uses of such rate of movement, rotational speed of the rotary table 116 (or, correspondingly the drill string 112), torque and axial loading (weight) made at the surface and/or in the MWD module 130 may be used in one more computers as will be explained further below.

The operation of the MWD and LWD instruments of FIG. 1 may be controlled by, and sensor measurements from the various sensors in the MWD and LWD modules and the other sensors disposed on the drilling and measurement unit described above may be recorded and analyzed using the surface logging, recording and control system 152. The surface logging, recording and control system 152 may include one or more processor-based computing systems or computers. In the present context, a processor may include a microprocessor, programmable logic devices (PLDs), field-gate programmable arrays (FPGAs), application-specific integrated circuits (ASICs), system-on-a-chip processors (SoCs), or any other suitable integrated circuit capable of executing encoded instructions stored, for example, on tangible computer-readable media (e.g., read-only memory, random access memory, a hard drive, optical disk, flash memory, etc.). Such instructions may correspond to, for instance, workflows and the like for carrying out a drilling operation, algorithms and routines for processing data received at the surface from the BHA 155 (e.g., as part of an inversion to obtain one or more desired formation parameters), and from the other sensors described above associated with the drilling and measurement system. The surface logging, recording and control system 152 may include one or more computer systems as will be explained with reference to FIG. 11. The other previously described sensors including the torque sensor 158D, the pressure sensor 158, the hookload sensor 157 and the hook elevation sensor 161 may all be in signal communication, e.g., wirelessly or by electrical cable with the surface logging, recording and control system 152. Measurements from the foregoing sensors and some of the sensors in the MWD and LWD modules may be used in various embodiments to be further explained below.

The flow volume or rate sensor 158B, the drilling fluid pressure sensor 158B and a drilling fluid return flow sensor 158C may be used during drilling activities such as drilling (lengthening the wellbore), reaming, circulating and washing the wellbore. The drilling fluid return flow sensor 158C may be implemented as a “paddle” coupled to a variable resistor, wherein an amount of deflection of the paddle by the drilling fluid return flow is related to a volumetric flow rate thereof. In some embodiments, the drilling fluid return flow sensor 158C may be implemented as a mass or volumetric flow rate sensor such as a Coriolis flow meter. A trip tank (not shown separately) may be used during “tripping” operations, wherein the pump(s) 129 are disconnected from the drill string 112 and segments of the drill string are coupled to or uncoupled from the drill string 112 in the wellbore 111 for partial or complete removal or insertion thereof. During tripping operations, the trip tank (not shown) may be in fluid communication with the wellbore 111 so that the volume of drilling fluid in the wellbore 111 displaced by “tripping in” may be stored and quantified. While “tripping out”, mud in the trip tank (not shown) may be pumped into the wellbore 111 to maintain the drilling fluid volume in the wellbore 111.

Example methods according to the present disclosure may use data on amounts of drilling fluid moved into the wellbore 111 compared with amounts of fluid leaving the wellbore 111 to make inferences and predictions as to the existence of or possible future occurrence of a well pressure control event, including without limitation, fluid influx from a formation, fluid loss to a formation and wellbore collapse.

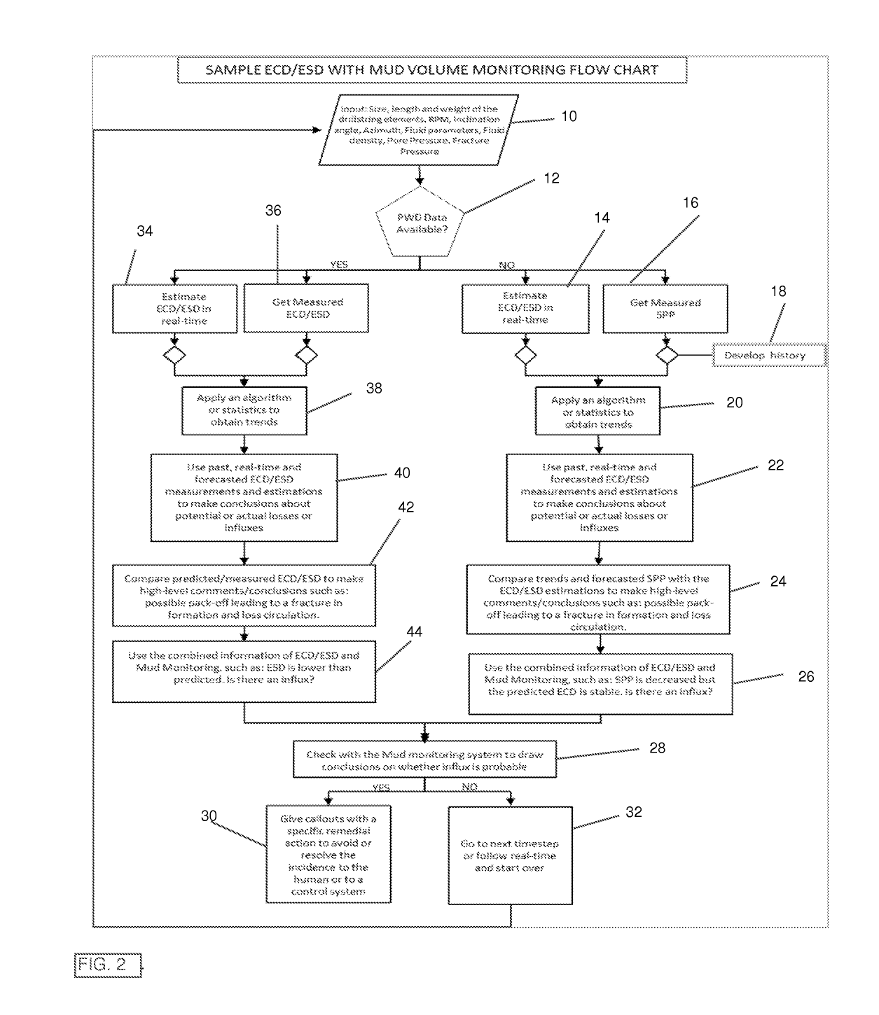

An example method according to the present disclosure is shown in a flow chart in FIG. 2. FIG. 2 is directed toward the case of drilling operations where the pump(s) (129 in FIG. 1) are operating as explained above with reference to FIG. 1. At 10 data may be input to the computer system (FIG. 7) concerning the configuration of the drill string, and measurements of drilling operating parameters and characteristics of the formations to be drilled, e.g., size, length and weight of the drill string elements, drill string rotation speed (RPM) as measured by the rotation sensor, wellbore inclination angle and azimuth as measured by sensors in the MWD module (130 in FIG. 1), drilling fluid parameters such as viscosity and density, formation fluid pore pressure, and formation fracture pressure. The formation fluid pore pressure and formation fracture pressure may be obtained, for example, from nearby (“offset”) wellbore data, or may be estimated, for example, from surface reflection seismic data, gravity data or integration of measurements of formation density made by a sensor in the LWD module (120 in FIG. 1). At 12, the example process may operate according to one of two different subprocesses, depending on whether wellbore annular pressure measurements (“PWD”) are available proximate the bottom of the drill string, e.g., as may be implemented as a pressure sensor in the MWD module (130 in FIG. 1).

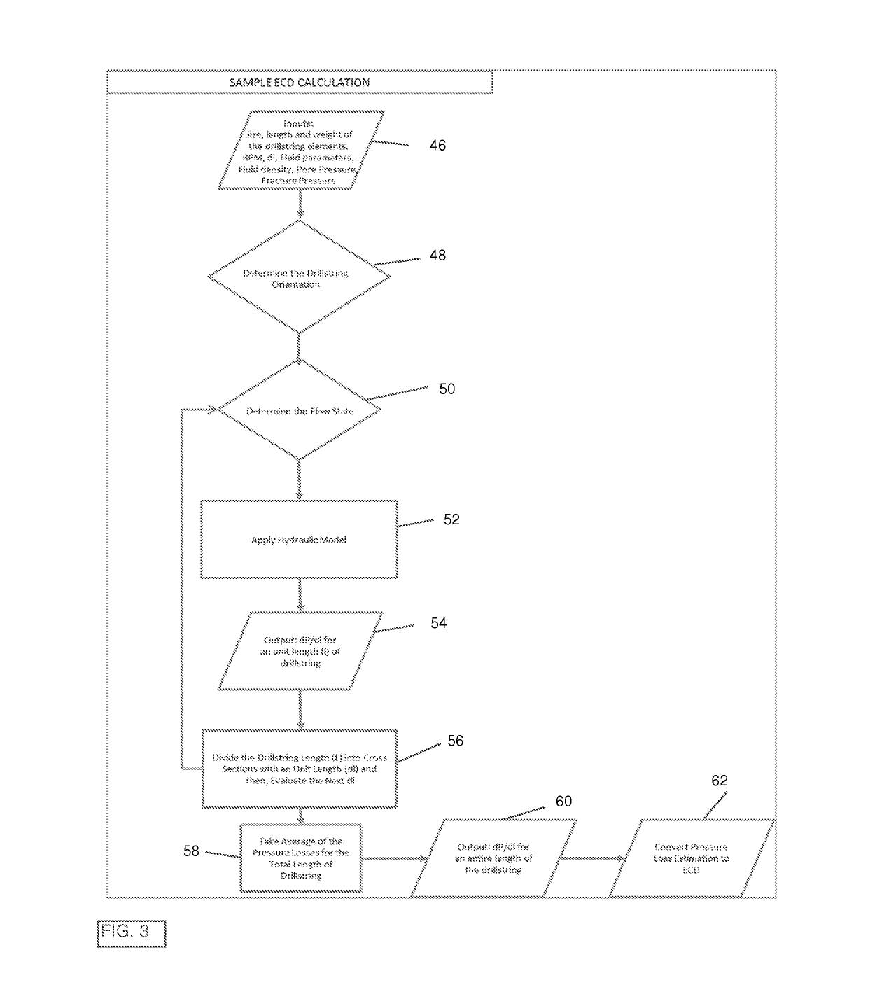

Assuming no PWD measurements are available, at 14, using the measured drill string or standpipe pressure (“SPP”) and flow rate at 16, e.g., as measured by the pressure sensor (158A in FIG. 1) and flow sensor (158B in FIG. 1), respectively, an equivalent circulating density (“ECD”), equivalent static density (“ESD”) and corresponding wellbore pressures along the wellbore may be estimated. An example method for estimating ECD will be further explained below with reference to FIG. 3. At 18, the measured values of SPP, fluid flow rate into the wellbore and calculated values of ECD/ESD may be stored in the computer system (e.g., in the recording unit 152 in FIG. 1) to develop a record thereof with respect to time. At 20, trends in the ECD/ESD and SPP may be identified using, for example, an algorithm described in U.S. Patent Application Publication No. 2011/0220410 filed by Aldred et al. At 22, identified trends in the prior recorded measurements and estimates and current measurements and estimates may be used to identify possible current-time fluid influxes or losses or well packoff. i.e., an accumulation of drill cuttings in the annular space that causes flow restriction or drill string movement restriction (based on the pore pressure, collapse pressure and fracture pressure profile of the wellbore) and/or to predict future possible fluid losses, packoff or influx events, again based on the foregoing pressure profile of the wellbore.

At 24, the foregoing past, current and forecast quantities may be supplemented with corresponding SPP data to infer more detailed conclusions concerning possible fluid losses, packoff or fluid influx events. At 26, the foregoing may be further combined with past recorded, current measurements and predicted future measurements of flow rate into the wellbore with flow rate out of the wellbore to infer possible well pressure control events. At 28, the computer system may use all the foregoing data to calculate whether a well pressure control event is occurring or is predicted to occur; if not, at 32, the system returns to measuring the foregoing described parameters at 10 and the foregoing process is repeated. If a well pressure control event is detected or forecast, at 30, an alarm indication may be calculated and displayed to suitable drilling operating personnel on any type of display in signal communication with the computer system, e.g., as may be included in the recording unit shown at 152 in FIG. 1. The alarm indication may include the type of event detected or predicted, the severity of the event detected or predicted and corrective action that may be undertaken to remediate or avoid the detected or predicted event. Using a similar process, if a well pressure control event is detected, the system may generate a command signal to an automatic drilling control unit to automate the process of taking corrective action. The alarm indications with the corresponding recommendations produced by the present example method may be displayed to the user and/or may be used as an input to a control system for the automation of well pressure control during drilling, tripping, etc. For example, assuming that ECD is forecast to exceed the formation fracture pressure after four “stands” (assembled segments of a plurality of individual “joints” of drill pipe and/or drilling tools) based on the current trend, the present example embodiment may cause the computer system (e.g., in 152 in FIG. 1) generate a command signal to a operate control unit to reduce the ECD by, e.g., decreasing the pump (129 in FIG. 1) rate. In other embodiments, the command signal may be used, for example, to open a variable orifice choke in the drilling fluid return line (see, e.g., U.S. Pat. No. 6,904,981 issued to van Riet).

At 34 and 36, if PWD data are available, actual values of ECD and ESD may be directly calculated from the PWD measurements. The remainder of the process, shown at 38, 40, 42 and 44 is substantially the same as the process where PWD are unavailable, and continues to the decision point at 28.

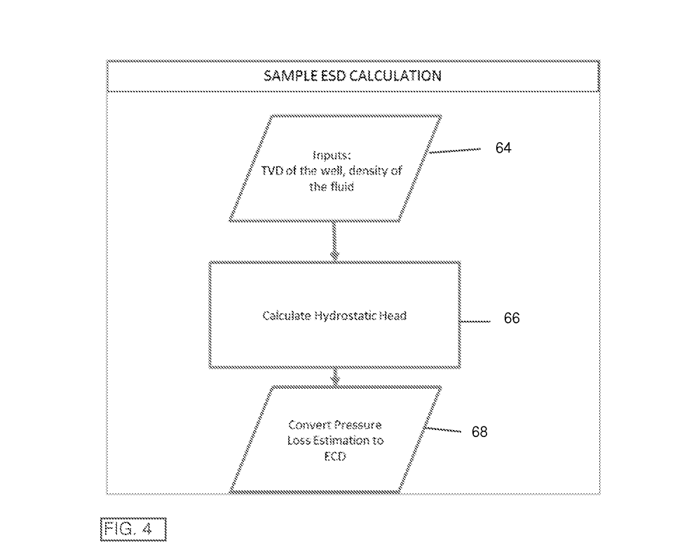

An example method for calculating ECD where no PWD data are available is described with reference to FIG. 3. At 46, data input to the computer system may include the configuration of the drill string, drilling operating parameters and characteristics of the formations to be drilling, e.g., size, length and weight of the drill string elements, drill string rotation speed (RPM), wellbore inclination angle and azimuth, drilling fluid parameters such as viscosity and density, formation fluid pore pressure, and formation fracture pressure. At 48 an orientation of the drill string is input. Such orientation may be obtained, for example by a direction sensor in the MWD module (130 in FIG. 1) coupled in the drill string. At 50 the flow state may be determined from the flow in sensor (158B in FIG. 1) and the SPP sensor (158A in FIG. 1) measurement. At 52, an hydraulics model may be used to calculate pressure loss along each of a plurality of segment of the drill pipe. Such hydraulics models are well known in the art and are used, for example in a process described in U.S. Pat. No. 6,904,981 issued to van Riet. At 54 the pressure loss per unit length along the drill string is calculated. At 56, the drill string may be further divided into cross sections and a pressure loss for each section may be calculated. At 58, a pressure loss for each section may be averaged over the entire drill string and at 60 summed to calculate a pressure loss over the entire drill string. At 62, the pressure loss may be converted to ECD. In FIG. 4, ESD estimates may be made using the drilling fluid density and true vertical depth of the wellbore at each measured depth at 64. At 66, a hydrostatic pressure may be calculated at each depth in the wellbore. At 68, an ESD may be calculated using the hydrostatic pressure.

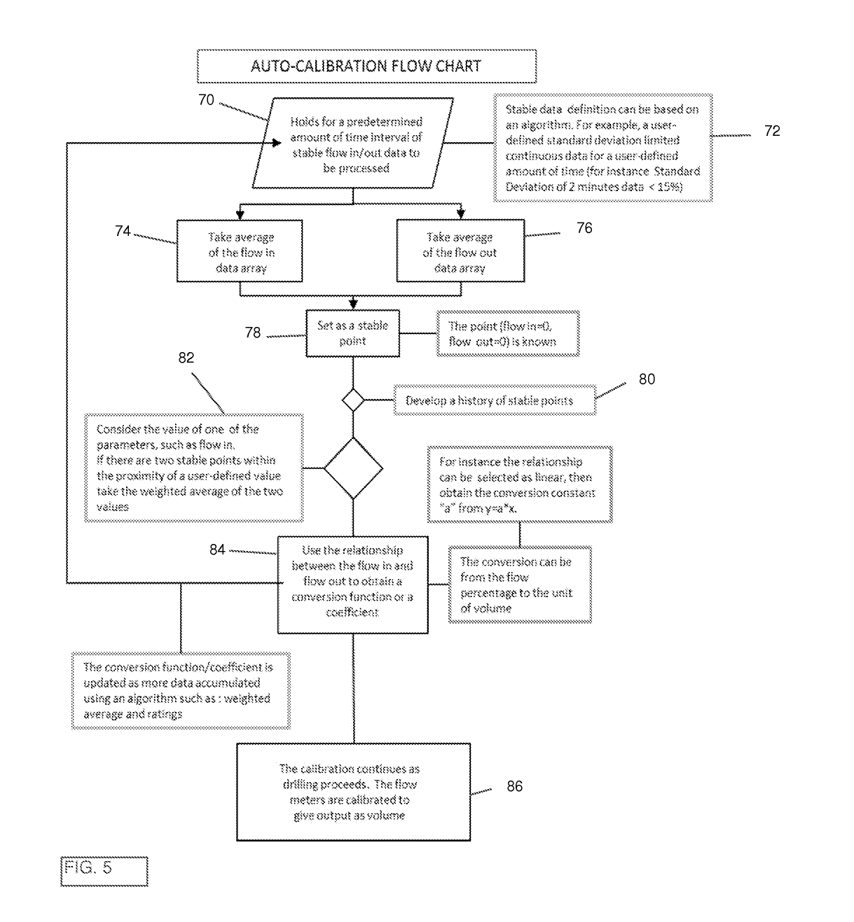

FIG. 5 shows an example procedure for automatically calibrating paddle type flow return sensor measurements into equivalent volumetric flow rates. The calibration of the paddle type flow return sensor may be performed during, but not limited to, running in after cementing a casing in the wellbore. After cementing, there is less likelihood of loss or influx and the geometry of the wellbore is well known and essentially fixed. The calibration of the paddle type flowmeter may be performed automatically by determining the run in following the cementing operation by analyzing measurements from surface sensors. By calibrating paddle type flow retrun sensors with respect to a stable flow-in measurement inside a casing, an equation can be generated corresponding to the relationship between flow rate and position of the paddle type flow return sensor. Such an equation may be used until the next run in following the cementing and the paddle type flow return sensor may be recalibrated inside the casing. In the present example, flow rate into the wellbore may be accurately estimated using the stroke counter or pump flow sensor (158B in FIG. 1). At 70 the computer system records wellbore mud flow return sensor (158C in FIG. 1) data for a selected amount of time in which mud flow in and mud flow out are stable and presumed to be substantially equal. At 72, stability may be defined as, for example, a user-defined standard deviation-limited continuous set of values for a user-defined amount of time (e.g., standard deviation of 2 minutes of data is less than a selected threshold such as 15 percent).

During identified stable flow periods, an average of the pump flow sensor measurements at 74 and the mud return measurements, at 76 may be made over a selected time interval. The foregoing may then be set as a “stable point” at 78, wherein the average flow return sensor measurement is correlated to the average flow rate measured by the pump flow sensor. As shown in FIG. 5, the point flow in=0, and flow out=0 may be entered into the flow return sensor measurement database. Stable points at various values of flow return sensor measurement averages may be generated and stored in the computer system at 80. At 82, one may consider the value of one of the parameters, such as mud flow rate into the wellbore. If there are two stable points within the proximity of a user-defined value, a weighted average of the two values may be calculated.

At 84, a relationship between flow rate into the wellbore and the averaged flow return sensor measurements may be used to generate a calibration coefficient to cause the flow return sensor measurement to be calibrated in volumetric flow rate out of the wellbore, if a non-volumetric flow rate type sensor is used. At 86, the foregoing calibration procedure may be repeated/continued as drilling proceeds to provide increasingly accurate correspondence between the flow return sensor measurement and the volumetric flow rate out of the wellbore.

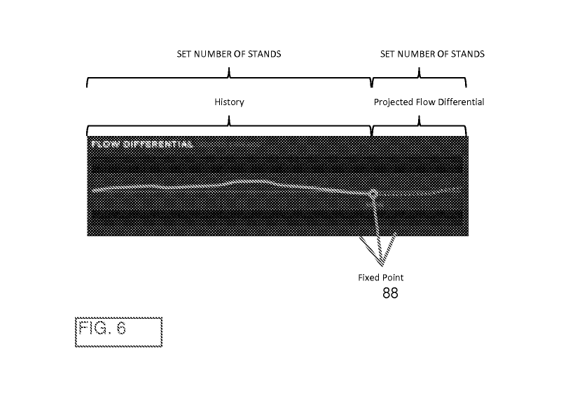

Having calibrated the flow return sensor measurements into values of volumetric flow rate out of the wellbore, the computer system may generate a display of flow rate in with respect to flow rate out for observation and use by appropriate drilling operating personnel. An example of such a plot is shown in FIG. 6 wherein a line represents prior recorded values of ratio of flow rate in to flow rate out. A value of unity (ratio=1) may be in the center of the vertical axis range in the plot in FIG. 6, with ratios above unity above the center line and ratios below unity below the center line. Flow ratio at the current time is shown at fixed point 88. Predicted ratio values are shown as dots to the right of the fixed point 88.

Having described the underlying process programmed into the computer system, operation of the system will now be explained, along with example alarms and possible corrective actions.

Initially, the display screen (see FIG. 7) of flow in/flow out may be empty. Flow measurement may starts from the fixed point. After a first user-defined number of joints or stands of the drill string (112 in FIG. 1) are moved, a projected flow differential (difference between flow rate into and out of the wellbore) is calculated and displayed. The projected flow differential covers a user-defined number of stands or joints ahead of the present drill string position based on identified trends in the prior recorded measurements of flow rate in and flow rate out.

The plot and the history data may be reset as the user's input. The computer system may also use historical data for a particular wellbore section, which may then be compared with real-time estimations/measurements to make conclusions and suggest corrective actions as may be required. The system may update the information on the screen for a user-defined amount of time. Regardless of the user-defined amount of time, real-time calculation continues in the background. If there is an alert/warning either from current measurements or from predicted measurements, the display may show the alarm without waiting for the user-defined amount of time. Or, the risk preventive actions can be commanded to the control system to change the input parameters accordingly. The alarms may be characterized by their severity. For example if certain parameters (e.g., flow rate in/flow rate out ratio) exceed corresponding selected threshold deviations from normal values by a first amount, a first level warning (displayed, for example in yellow) may be displayed. If the parameters exceed a second, larger threshold deviation from normal values, a second level warning (e.g., displayed in red) may be displayed. Examples of such warnings and suggestions may include, without limitation the following.

### ECD Approaching Fracture Gradient (FG):

The computer system predicts that the ECD is going to pass the FG and gives a yellow alert. Recommends to reduce the flow rate, reduce the RPM, etc. or gives a command to an automatic drilling control system (“control system”). The prediction is based on the calculated or measured ECD by PWD.

### Fracture Gradient Crossed:

The computer system generates a warning signal when the FG is crossed using either measured or calculated ECD. Recommends to decrease the mud weight, reduce the flow rate, reduce the RPM, etc. or gives a command to the control system.
ESD is Lower than Collapse Gradient (CG):
The computer system generates a warning signal when the measured or calculated ESD is lower than the CG. Recommends to increase the mud weight or gives command to the control system.
ESD is Lower than Pore Pressure Gradient (PP):
The computer system generates a warning indicator when the measured or calculated ESD is lower than the PP. Recommends to perform a flow check, increase the mud weight or gives a command to the control system.

### Mud Tank Level is Increased by X BBL {X<=User-Defined Volume}:

The computer system generates a warning indicator when mud tank levels increases by using the total mud volume input. Recommends to perform a flow check (stop the pumps, observe the flow coming from the wellbore) or gives a command to the control system.

### Mud Tank Level is Decreased by X BBL {X<=User-Defined Volume BBL}:

The computer system generates a warning indicator when mud tank levels decreases by using the total mud volume input. Recommends to perform a flow check (stop the pumps, observe the wellbore fluid level) or gives a command to the control system.

Examples of second level alerts and suggested corrective may include the following, without limitation.

### Flow Out Decreased:

The computer system generates a warning indicator when the trend of the FO decreases. Recommends to perform a flow check (stop the pumps, observe the wellbore fluid level) or gives a command to the control system.

### Flow Out Increased:

The computer system generates a warning indicator when the trend of the FO increases. Recommends to perform a flow check (stop the pumps, observe the wellbore fluid level) or gives a command to the control system.

### Mud Tank Level is Increased by X BBL {X>User-Defined Volume BBL}:

The computer system generates a warning indicator when mud tank levels increase by using the total mud volume input. Recommends to perform a flow check (stop the pumps, observe the wellbore fluid level) or gives a command to the control system.

### Mud Tank Level is Decreased by X BBL {X>User-Defined Volume BBL}:

The computer system generates a warning indicator when mud tank levels decreases by using the total mud volume input. Recommends to perform a flow check (stop the pumps, observe the wellbore fluid level) or gives a command to the control system.

The foregoing warning indicators may be generated during times when the mud pump(s) are connected to the drill string and are operating. During tripping operations, trip tank levels may be used to generate example warnings such as the following, without limitation.

During tripping in, the computer system may combine the information of mud volume tracking and ECD/ESD. With the combined information the system uses the estimated/measured data to present conclusions. For example if there is a possibility of fluid loss determined from the trip tank mud volume monitoring, the computer system queries the ECD/ESD to display a warning and recommended remedial action. The system updates the information on the display for a user-defined amount of time. Regardless of the user-defined amount of time, real-time calculation continues in the background. If there is an alarm condition, the computer system displays the alarm and possible corrective action to the user or to the automatic drilling control system without waiting for the user-defined amount of time.

As an example, while tripping in, the drilling unit operator can move the drill string in too fast and it can result in inducing a fracture due to surge pressure. Then, when checking the mud level elevation (predicted as a result of expected drill string fluid displacement) will be less than expected. The system can detect the change and generate the appropriate alarm display. The system can show the expected trip tank elevation and compare it with the drill string displacement and actual trip tank elevation. For example, the drill string is expected to displace two barrels (330 liters) of drilling fluid, but the drilling fluid elevation in the tank (127 in FIG. 1 rises an amount corresponding to only 0.5 barrels (82 liters), then the computer system may generate and display a first level or second level alarm indicator depending on the user's definition of the alarm indicator levels.

Conversely, while tripping out, the drilling unit operator can move the drill string too fast, which may result in a fluid influx or wellbore collapse due to swab pressure effects. The system will identify a discrepancy between the expected decrease in level in the trip tank based on the displacement volume of the drill string removed from the wellbore and the actual level of the trip tank.

For example, the drill string volume removed may be 2 barrels (330 liters) and mud return to the tank is only 0.5 barrels (82 liters). When the wellbore is filled from the trip tank only 0.5 barrels (82 liters) can be filled. This means there is a possible influx of fluid into the wellbore. The wellbore is filled using the trip tank for each interval of a selected number of stands, for example five stands. The computer system will calculate and record any deviation between expected trip tank level and actual trip tank level. The computer system may generate and display a first or second level alarm indicator depending on the user's definition of the alarm thresholds.

FIG. 7 shows an example computing system 100 in accordance with some embodiments. The computing system 100 may be an individual computer system 101A or an arrangement of distributed computer systems. The computer system 101A may include one or more analysis modules 102 that may be configured to perform various tasks according to some embodiments, such as the tasks depicted in FIGS. 1 through 5. To perform these various tasks, analysis module 102 may execute independently, or in coordination with, one or more processors 104, which may be connected to one or more storage media 106. The processor(s) 104 may also be connected to a network interface 108 to allow the computer system 101A to communicate over a data network 110 with one or more additional computer systems and/or computing systems, such as 101B, 101C, and/or 101D (note that computer systems 101B, 101C and/or 101D may or may not share the same architecture as computer system 101A, and may be located in different physical locations, for example, computer systems 101A and 101B may be at a well drilling location, while in communication with one or more computer systems such as 101C and/or 101D that may be located in one or more data centers on shore, aboard ships, and/or located in varying countries on different continents).

A processor can include a microprocessor, microcontroller, processor module or subsystem, programmable integrated circuit, programmable gate array, or another control or computing device.

The storage media 106 can be implemented as one or more computer-readable or machine-readable storage media. Note that while in the exemplary embodiment of FIG. the storage media 106 are depicted as within computer system 101A, in some embodiments, the storage media 106 may be distributed within and/or across multiple internal and/or external enclosures of computing system 101A and/or additional computing systems. Storage media 106 may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices. Note that the instructions discussed above may be provided on one computer-readable or machine-readable storage medium, or alternatively, can be provided on multiple computer-readable or machine-readable storage media distributed in a large system having possibly plural nodes. Such computer-readable or machine-readable storage medium or media may be considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

It should be appreciated that computing system 100 is only one example of a computing system, and that computing system 100 may have more or fewer components than shown, may combine additional components not depicted in the example embodiment of FIG. 7, and/or computing system 100 may have a different configuration or arrangement of the components depicted in FIG. 7. The various components shown in FIG. 7 may be implemented in hardware, software, or a combination of both hardware and software, including one or more signal processing and/or application specific integrated circuits.

Further, the steps in the processing methods described above may be implemented by running one or more functional modules in information processing apparatus such as general purpose processors or application specific chips, such as ASICs, FPGAs, PLDs, or other appropriate devices. These modules, combinations of these modules, and/or their combination with general hardware are all included within the scope of the present disclosure.

A system according to the present disclosure may provide one or more of the following advantages. In contrast to tracking systems known in the art, a system or method according to the present disclosure uses ECD & ESD measurements and/or estimations together with a mud monitoring algorithm to present a comprehensive advisory system through the drilling process, such as drilling, tripping, etc. The present example system includes an adaptive sensor recalibration of flow meters such as a flow paddle through the drilling process for all hole sections. The present example system may provide alarms, recommendations and remedial actions for the specific present or potential problem to a human operator or to a control system. A method or system according to the present disclosure may projects estimated flow differential values based on real-time and historical measurements and estimations and make conclusions specific to the type of well pressure control event.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for identifying and predicting well pressure control events, comprising:
pumping fluid into a wellbore and collecting fluid returning from the wellbore;
measuring at least a first parameter related to a rate of flow of fluid pumped into the wellbore;
measuring at least a second parameter related to a rate of flow of fluid out of the wellbore;
in a computer, using the first and second parameters and selected properties of the fluid, calculating an equivalent density of the fluid during pumping (ECD) and when pumping is stopped (ESD); and
in the computer, generating and displaying an alarm when at least one of the following occurs;
ECD is at least equal to a fracture pressure of at least one formation in the wellbore.
ESD is at most equal to a fluid pore pressure of at least one formation in the wellbore, and
ESD is at most equal to a collapse pressure of the wellbore.

2. The method of claim 1 further comprising displaying a corrective action calculated in the computer.

3. The method of claim 1 further comprising, in the computer comparing the first parameter and the second parameter and displaying an alarm indicative of a fluid influx when: the second parameter exceeds the first parameter by a selected amount; or displaying an alarm indicative of fluid loss when the first parameter exceeds the second parameter by a selected amount.

4. The method of claim 3 further comprising displaying a first level alarm when the first parameter exceeds the second parameter or the second parameter exceeds the first parameter by a first selected amount and displaying a second level alarm when the first parameter exceeds the second parameter or the second parameter exceeds the first parameter by a second selected amount greater than the first selected amount.

5. The method of claim 1 further comprising:
recording the first parameter and the second parameter over a selected length of the wellbore; in the computer identifying trends in the first parameter and the second parameter; and in the computer, generating and displaying an alarm when at least one of the following occurs at a selected distance from a current position of a drill string in the wellbore;
the identified trends indicate that the ECD is expected to be at least equal to the fracture pressure of at least one formation in the wellbore,
the identified trends indicate that the ESD is expected to be at most equal to the fluid pore pressure of at least one formation in the wellbore, and
the identified trends indicate that the ESD is expected to be at most equal to a collapse pressure of the wellbore.

6. The method of claim 5 further comprising displaying a corrective action calculated in the computer.

7. The method of claim 1 wherein the first parameter comprises measurements made by a stroke counter on a drilling unit fluid pump.

8. The method of claim 1 wherein the second parameter comprises measurements made by a paddle flowmeter disposed in a fluid return line from the wellbore.

9. The method of claim 1 wherein the flowmeter measurements are calibrated into volumetric flow rate preferably but not limited to inside a newly cemented casing, by:
determining a first time interval of a substantially stable first fluid flow rate into the wellbore;
in the computer, averaging measurements from the paddle flowmeter over the first time interval;
determining if any additional time interval of a substantially stable second fluid flow rate into the wellbore;
in the computer, averaging measurements from the paddle flowmeter over the if any additional time interval; and
using the averages, the fluid flow rate to convert output of the paddle flowmeter into volumetric flow rate.

10. The method of claim 1 further comprising:
during tripping operations, measuring a fluid level in a tank;
in the computer, using the measured fluid level to determine if;
a volume of fluid in the tank increases by more than a displacement volume of a drill string when the drill string is moving into the wellbore,
a volume of the fluid increases by less than the displacement volume when the drill string is moving into the wellbore.
a volume of fluid in the tank decreases by more than a displacement volume of a drill string when the drill string is moving out of the wellbore,
a volume of the fluid decreases by less than the displacement volume when the drill string is moving out of the wellbore and
in the computer generating and displaying an alarm when any of the foregoing conditions is determined to exist.

11. The method of claim 10 further comprising displaying a corrective action calculated in the computer.

12. A system for identifying and predicting well pressure control events, comprising:
a first sensor for measuring at least a first parameter related to a rate of flow of fluid pumped into a wellbore, the sensor in signal communication with a computer;
a second sensor for measuring at least a second parameter related to a rate of flow of fluid out of the wellbore, the second sensor in signal communication with the computer;
wherein the computer comprises instructions programmed therein for using the first and second parameters and selected properties of the fluid to calculate an equivalent density of the fluid during pumping (ECD) and when pumping is stopped (ESD); and
wherein the computer comprises instructions programmed therein to generate an alarm indicator and to operate a display in signal communication with the computer to display the alarm indicator when at least one of the following occurs;
ECD is at least equal to a fracture pressure of at least one formation in the wellbore.
ESD is at most equal to a fluid pore pressure of at least one formation in the wellbore, and
ESD is at most equal to a collapse pressure of the wellbore.

13. The system of claim 12 wherein the computer further comprises instructions programmed therein to calculate and operate the display to show a corrective action.

14. The system of claim 12 wherein the computer further comprises instructions programmed therein to cause the computer to compare the first parameter and the second parameter and to operate the display to show an alarm indicative of a fluid influx when: the second parameter exceeds the first parameter by a selected amount; or to operate the display to show an alarm indicative of fluid loss when the first parameter exceeds the second parameter by a selected amount.

15. The system of claim 14 wherein the computer further comprises instructions programmed therein to operate the display to show a first level alarm when the first parameter exceeds the second parameter or the second parameter exceeds the first parameter by a first selected amount and to operate the display to show a second level alarm when the first parameter exceeds the second parameter or the second parameter exceeds the first parameter by a second selected amount greater than the first selected amount.

16. The system of claim 12 wherein the computer further comprises instructions programmed therein to:
record the first parameter and the second parameter over a selected length of the wellbore;
to identify trends in the first parameter and the second parameter; and
to operate the display to show an alarm indication when at least one of the following occurs at a selected distance from a current position of a drill string in the wellbore;
the identified trends indicate that the ECD is expected to be at least equal to the fracture pressure of at least one formation in the wellbore,
the identified trends indicate that the ESD is expected to be at most equal to the fluid pore pressure of at least one formation in the wellbore, and
the identified trends indicate that the ESD is expected to be at most equal to a collapse pressure of the wellbore.

17. The system of claim 16 wherein the computer further comprises instructions to calculate and to operate the display to show a corrective action.

18. The system of claim 12 wherein the first parameter comprises measurements made by a stroke counter on a drilling unit fluid pump.

19. The system of claim 12 wherein the second parameter comprises measurements made by a paddle flowmeter disposed in a fluid return line from the wellbore.

20. The system of claim 12 wherein the computer comprises instructions therein to calibrate paddle flowmeter measurements into a volumetric flow rate by:
determining a first time interval of a substantially stable first fluid flow rate into the wellbore from measurements of the first parameter;
averaging measurements from the paddle flowmeter over the first time interval;
determining a second time interval of a substantially stable second fluid flow rate into the wellbore using measurements of the first parameter;
averaging measurements from the paddle flowmeter over the second time interval; and
using the averaged measurements, the first fluid flow rate and the second fluid flow rate to convert output of the paddle flowmeter into the volumetric flow rate.

21. The system of claim 1 wherein the computer further comprises instructions programmed therein to:
during tripping operations, measure a fluid level in a tank;
using the measured fluid level to calculate when at least one of a plurality of conditions exists comprising;
a volume of fluid in the tank increases by more than a displacement volume of a drill string when the drill string is moving into the wellbore,
a volume of the fluid increases by less than the displacement volume when the drill string is moving into the wellbore.
a volume of fluid in the tank decreases by more than a displacement volume of a drill string when the drill string is moving out of the wellbore,
a volume of the fluid decreases by less than the displacement volume when the drill string is moving out of the wellbore and
to generate an alarm indicator and to operate the display to show the alarm when any of the foregoing conditions is determined to exist.

22. The system of claim 21 wherein the computer further comprises instructions programmed therein to operate the display to show a corrective action.
